(19) United States
(12) Patent Application Publication
(10) Pub. No.: US 2017/0136878 A1
(43) Pub. Date: May 18, 2017

(54) METHOD FOR OPERATING A MOTOR VEHICLE IN DIFFERENT DRIVING MODES, AND MOTOR VEHICLE

(71) Applicant: DAIMLER AG, Stuttgart (DE)

(72) Inventors: Peter FRANK, Filderstadt (DE); Marie FRIEDRICH, Stuttgart (DE); Friedemann KUHN, Reutlingen (DE); Hans-Josef KÜTING, Remseck (DE)

(21) Appl. No.: 15/323,489

(22) PCT Filed: Jun. 27, 2015
(86) PCT No.: PCT/EP2015/001301

§ 371 Date: Jan. 3, 2017

(30) Foreign Application Priority Data
Jul. 4, 2014 (DE) 10 2014 009 985.7

(51) Int. Cl. B60K 35/00; G05D 1/00; G06T 11/60; G05D 1/02

(52) U.S. Cl. CPC B60K 35/00; G05D 1/021; G05D 1/0055; G06T 11/60; B60K 2350/96; B60K 2350/2052; B60Q 9/00

(57) ABSTRACT

A method for operating a motor vehicle involves displaying a first assistance graphic of a first active driver assistance system in a first display mode on at least one display device of the motor vehicle when the motor vehicle is operated in a first driving mode, and displaying the first assistance graphic of the first active driver assistance system in a second display mode on the at least one display device when the motor vehicle is operated in a second driving mode that is different from the first driving mode. The first assistance graphic is displayed in a first perspective in the first display mode and is displayed in a second perspective, which is different from the first perspective, in the second display mode.

### BACKGROUND AND SUMMARY OF THE INVENTION

Exemplary embodiments of the invention relate to a method for operating a motor vehicle that involves displaying a first assistance graphic of a first active driver assistance system in a first display mode on at least one display device of the motor vehicle when the motor vehicle is operated in a first driving mode, and displaying the first assistance graphic of the first active driver assistance system in a second display mode on the at least one display device when the motor vehicle is operated in a second driving mode which is different from the first driving mode. In addition, exemplary embodiments of the present invention also relate to a motor vehicle.

Modern motor vehicles usually have driver assistance systems. Driver assistance systems are electronic additional devices in motor vehicles supporting the driver in certain driving situations. Such support of the driver is also referred to as assisted driving. Here, an assistance graphic can be assigned to a state of a driver assistance system, the assistance graphic being displayed to the driver on a screen, i.e., a display, of the motor vehicle. This state of the driver assistance system is generally displayed in a defined perspective, for example in a so-called top view or a 2.5 D perspective.

Intermediate stages are provided with the development towards autonomous driving in which the vehicle can drive automatically and without intervention from the driver. Here, a degree of automation is assigned to each stage. Different tasks can be assigned to the driver in these intermediate stages. For example, the driver can act as a monitor to the “passenger”, who should take back control of the driving task at a defined point in time.

In current assistance graphics or driver assistance displays, there is indeed separation between different driving tasks, but there is no intuitive or holistic separation between different degrees of automation and correspondingly it is not made clear which tasks are bestowed on the driver. This disadvantageously increases demands placed on the driver when the degree of automation is increased and intuitive operation of the motor vehicle is thus made difficult for the driver.

The operation of a motor vehicle with different degrees of automation is known from German patent document DE 10 2009 048 954 A1. Furthermore, a driver is provided with a secondary task that does not relate to the driving operation of the motor vehicle when the motor vehicle is in an autonomous driving operation. The driver is given a specific warning, which depends on a degree of automation. The warning indicates an activity of a driver assistance system during the partially autonomous and autonomous driving.

Exemplary embodiments of the present invention provide a method enabling a particularly safe, intuitive, and comfortable operation of a motor vehicle in all degrees of automation.

A method according to the invention serves for the operation of a motor vehicle. The method comprises displaying a first assistance graphic of a first active driver assistance system in a first display mode on at least one display device of the motor vehicle when the motor vehicle is operated in a first driving mode, and displaying the first assistance graphic of the first active driver assistance system in a second display mode on the at least one display device when the motor vehicle is operated in a second driving mode which is different from the first driving mode.

In order to now make the method particularly safe, intuitive and comfortable, provision is made according to the invention for the first assistance graphic to be displayed in a first perspective in the first display mode and to be displayed in a second perspective which is different from the first perspective in the second display mode.

In other words, this means that the motor vehicle can be operated in different driving modes. Thus, a first driver assistance system can be active, which is, for example, a regulation for longitudinal dynamics and/or transverse dynamics, which intervenes to provide support in the event of a driving error and/or inattentiveness of a driver of the motor vehicle. Such a driver assistance system can be, for example, a navigation system, a lane change assistant, a parking assistant or adaptive cruise control. A first assistance graphic can be assigned to the first active driver assistance system, which can be displayed on at least one display device of the motor vehicle. Here, the first assistance graphic can be displayed in different display modes, wherein one display mode is assigned to each driving mode. The display mode can therefore be controlled by a control device, for example, depending on the driving mode.

In order to make it visually clear to the driver which driving mode the motor vehicle is in, the first assistance graphic is depicted in a first perspective when the first driving mode is activated and in a second perspective which is different from the first perspective when the second driving mode is activated. Possible perspectives can, for example, be a central perspective, a bird's eye perspective or a fisheye perspective. Thanks to this visualization of the driving mode by means of a perspective of the first assistance graphic adapting to the driving mode, the driver can be shown the extent of the degree of automation in a particularly intuitive manner. The extent of the degree of automation is to be understood here as a proportion of a driver assistance system on vehicle guidance. Thus, the driver's attention can be drawn in a particularly advantageous manner to the information relevant for the driving task and the motor vehicle can thus be operated more safely.

One embodiment of the method provides that the assistance graphic is displayed on a head-up display and/or a display of a combination instrument of the motor vehicle and/or a display of a head unit of the motor vehicle as the at least one display device. The display of a combination instrument can generally be found behind the steering wheel of the motor vehicle and is thus particularly visible for a driver of the motor vehicle. In the case of a head-up display, the first assistance graphic can be projected to the driver onto the windscreen, i.e., directly in the driver's field of vision, which comprises the road on which the vehicle is moving. This is referred to as augmented reality and enables the driver to guide the motor vehicle in a particularly safe manner since the driver does not have to take his/her eyes off the road, in particular off the current driving situation, in order to look at a display, for example. The first assistance graphic can also be displayed on a display of the head unit. The head unit is generally located in a center console of the motor vehicle. Thus, the first assistance graphic can also easily be seen by other vehicle passengers, for example, a front-seat passenger.

The motor vehicle is particularly preferably operated in a partially automated manner in the first driving mode and in a highly automated manner in the second driving mode. During partially automated driving, the motor vehicle can be operated by the driver and the first active driver assistance system. Here, the first assistance graphic of the first active driver assistance system is displayed on the at least one display device in a first perspective, which enables a driver to monitor the operation of the first active driver assistance system in a particularly simple manner. The driver is thereby in a position to judge whether the maneuvers carried out by the first active driver assistance system are controlled by the first active driver assistance system. In the event of possible disruptions, the driver can immediately intervene and completely take back control of vehicle guidance. The driver is therefore always in a control circuit of the first active driver assistance system and is responsible for vehicle guidance. During highly automated driving, the vehicle can, for a certain period of time and in specific situations, drive automatically and without the driver's influence. The driver can thus hand over vehicle guidance to the vehicle, which, for example, is operated by the first active driver assistance system. The driver does not have to constantly monitor the vehicle. However, the driver should be in a position to be able to take over vehicle guidance with sufficient leeway. In order to make taking over the vehicle particularly easy and safe for the driver, the first assistance graphic of the first active driver assistance system is depicted in a second perspective. Here, the second perspective can be selected in such a way that the maneuvers of the first active driver assistance system are made clear to the driver at all times. After a sufficient warning time, the driver can take back control of vehicle guidance. If the driver does not manage it in the predetermined period of time, the vehicle is transferred into a secure state. Thus, the method is designed to be particularly safe.

In one embodiment of the method, the first assistance graphic comprises at least one region in the surroundings of the motor vehicle and/or at least one hazard in the surroundings of the motor vehicle, wherein the at least one region and/or the at least one hazard are detected by a detection means of the first active driver assistance system. Such a detection means can, for example, be a sensor system of the motor vehicle, wherein the sensor data are processed by means of the first active driver assistance system. For example, a region in the surroundings of the motor vehicle or a hazard in the surroundings of the motor vehicle can be detected and depicted on the at least one display device. The passengers of the motor vehicle can thus be informed about potentially dangerous situations detected and recognized by the motor vehicle.

Provision can be made for the at least one region in the first display mode to be marked by a first marking and the region in the second display mode to be marked by a second marking that is different from the first marking, wherein the first marking highlights the at least one region for monitoring by the driver and the second marking highlights the at least one region that is monitored by the first active driver assistance system. The surroundings of the motor vehicle are depicted in a first perspective in the first assistance graphic in the first display mode. In the first display mode, the motor vehicle is in the first driving mode, for example in the partially automated driving mode. In this driving mode, the driver can serve as a monitor for the operation of the first active driver assistance system. A marking of these regions can be provided to highlight to the driver in the first assistance graphic which regions in the surroundings of the motor vehicle the driver should monitor. As such, the regions to be monitored can be highlighted in color in order to direct the driver's attention to the regions to be monitored. In the second display mode, the first assistance graphic is depicted in a second perspective. In the second display mode, the motor vehicle is in the second driving mode, for example in the highly automated driving mode. Here, the areas of the motor vehicle surroundings monitored by the first active driver assistance system by the motor vehicle itself can be visually highlighted to the driver on the assistance graphic.

Alternatively or additionally, in the second driving mode, a planned driving maneuver of the first active driver assistance system is displayed on the at least on display device. In order for the people driven by the vehicle to feel particularly safe, the driving maneuver taking place within the next couple of seconds can be displayed. The vehicle passengers are thus informed at all times about which maneuver will be carried out in the future. If necessary, the driver can also intervene if he does not agree with the planned maneuver.

Preferably, at least one third driving mode is provided, in which the first assistance graphic is displayed in a third perspective on the at least one display device in a third display mode. Such a third driving mode can, for example, be an assisted driving mode, in which the driver drives the vehicle himself, i.e., operates the vehicle manually. Here, the driver can be supported in the driving task by the first driver assistance system. Here, the assistance graphic is displayed to him in a third display mode, i.e., in a third perspective.

It is furthermore advantageous when a second assistance graphic of at least one second driver assistance system, which is only active for a predetermined period of time, is depicted on the at least one display device in such a way that the second assistance graphic covers the first assistance graphic. Thus, several driver assistance systems can be active. The driver can thereby choose which assistance graphic, for example the first assistance graphic, is depicted on the at least one display device. If, for example, the second driver assistance system is activated by a driving error of the driver, then the second driver assistance system can control the vehicle in such a way that the driving error is compensated for. During this period of time in which the second driver assistance system carries out this maneuver, a second assistance graphic, which visualizes the maneuver to the driver, for example as a so-called pop-up, can slide over the first assistance graphic and cover it. If, in particular, the driving mode is changed by the intervention of the second driver assistance system, i.e. for example from the third driving mode into the first driving mode, then the perspective of the assistance graphics also changes correspondingly.

Provision can be made to issue a warning signal before switching from the second driving mode into the first driving mode. If the motor vehicle is in the second driving mode, i.e., in a highly automated driving mode, then it should be signaled to the driver in the event of a switch into the first driving mode, i.e., into the partially automated driving mode, that the driver should now take back control of the driving task. In particular, it should be made clear to the driver that the driver should monitor the surroundings of the motor vehicle himself/herself, for example. Therefore, a particularly safe transition between the two driving modes can be provided by means of the warning signal. The warning signal is particularly preferably issued visually and/or acoustically and/or haptically. Writing on the at least one display device can be provided, for example, as a visual warning signal, which makes it clear to the driver that he/she should observe the current traffic situation, for example. Insertion of a video image of the current traffic situation can also be provided as a visual warning signal. An acoustic warning signal can be, for example, a sound or an electronic announcement.

A motor vehicle according to the invention comprises a control device formed to perform a method according to the invention.

### BRIEF DESCRIPTION OF THE DRAWINGS

The invention is explained in more detail below with the aid of a preferred exemplary embodiment as well as with reference to the appended drawings.

Here are shown:

FIG. 1 a schematic depiction of a display device of a motor vehicle, on which an assistance graphic is depicted in a third perspective;

FIG. 2 a schematic depiction of the display device of the motor vehicle, on which an additional assistance graphic is depicted in a third perspective;

FIG. 3 a schematic depiction of the display device of the motor vehicle, on which the assistance graphic is depicted in a first perspective;

FIG. 4 a schematic depiction of one embodiment of the display device of the motor vehicle, on which the assistance graphic is depicted in a second perspective;

FIG. 5 a schematic depiction of an additional embodiment of the display device of the motor vehicle, on which the assistance graphic is depicted in the second perspective; and

FIG. 6 a schematic depiction of an additional embodiment of the display device of the motor vehicle, on which the assistance graphic is depicted in the third perspective.

### DETAILED DESCRIPTION

The exemplary embodiment illustrated below is a preferred embodiment of the invention. In the exemplary embodiment, however, the described components of the embodiment respectively represent individual features of the invention that are to be considered independently of one another and which also respectively develop the invention independently of one another and are thus also to be considered individually or in a combination other than that shown as an integral part of the invention. Furthermore, the described embodiment can also be supplemented by further features of the invention that have already been described.

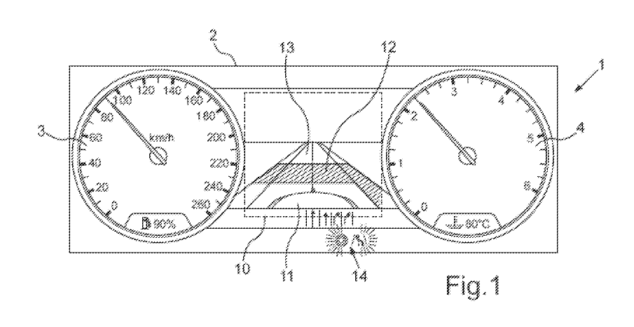

FIG. 1 shows a display device 1 of a motor vehicle. The motor vehicle is in a third driving mode in this embodiment, in particular in an assisted driving mode. Here, the motor vehicle is driven by a driver, wherein the driver is supported in his driving task by a first active driver assistance system. Such a first driver assistance system can, for example, be a radar-based adaptive cruise control that is also referred to as DTR (Distronic Plus). The adaptive cruise control can support the driver in the driving task in such a way that the motor vehicle automatically holds a distance from another vehicle located on the on the road in front of the motor vehicle controlled by the driver. In addition, further driver assistance systems can be provided which can support the driver in his driving task. Further driver assistance systems can, for example, be a lane change assistant or a parking assistant.

The display device 1 is implemented here as a display 2 of a combination instrument. The combination instrument can, for example, be arranged behind a steering wheel of the motor vehicle. The combination instrument can comprise a speedometer 3 and an r.p.m. counter 4, which can be implemented as mechanical displays or can be depicted on the display 2 of the combination instrument. In addition, fuel gauges, coolant temperature gauge, indicator lamps and direction indicators can be provided in the combination instrument, for example.

A first assistance graphic 10 can be depicted on the display 2 of the combination instrument, the assistance graphic being assigned to the first driver assistance system. The first assistance graphic 10 can, however, also be depicted on a head-up display or another display of the motor vehicle.

The first assistance graphic 10 can, for example, display the surroundings of the motor vehicle detected by a detection device of the first active driver assistance system. Since the motor vehicle is operated in the assisted driving mode in this exemplary embodiment, the first assistance graphic is displayed in a third display mode, i.e., in a third perspective. The third perspective is implemented here as a central perspective. The surroundings of the motor vehicle are displayed to the driver as if the driver were looking out of a windscreen of the vehicle onto a road on which the motor vehicle is driving. In order to give this impression, a hood of a virtual motor vehicle 11 and a virtual road 13 are depicted on the assistance graphic 10.

Since the driver is supported by the first active driver assistance system in the assisted driving mode, it is possible to use the first assistance graphic 10 to display, for example, the regions 12 in the surroundings of the motor vehicle that are to be given particular attention by the driver. The regions 12 can thereby be visually highlighted, for example marked in color, in order to draw the driver's attention to the regions 12 to be monitored.

If further driver assistance systems are provided, these can be displayed by additional symbols 14 on the display 2 of the combination instrument. Symbols 14 can light up to visualize an active state of the further driver assistance system. Provision can be made for the driver to be able to select the assistance graphic of a driver assistance system that the driver would like to be left permanently on the display device.

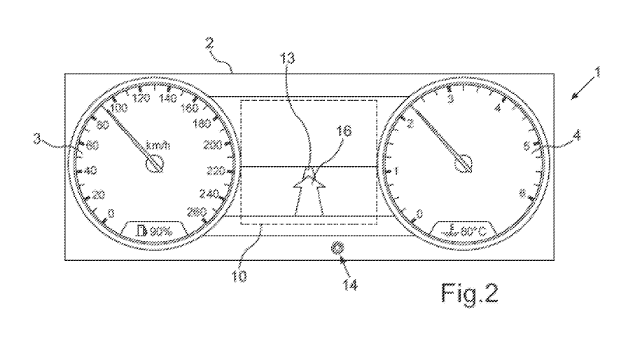

FIG. 2 shows the display device 1 of the motor vehicle from FIG. 1. The motor vehicle is in a third driving mode. In this exemplary embodiment, the driver of the motor vehicle is supported by a first driver assistance system, which serves for navigation. The first assistance graphic 10 of the navigation system is depicted on the display 2 of the combination instrument. Since the motor vehicle is operated in the third driving mode, the first assistance graphic 10 is displayed in a third perspective, for example the central perspective. In the first assistance graphic 10, arrows 16, for example, are displayed to the driver on the virtual road 13, the arrows serving for navigation. In addition, a symbol 14 of a further driver assistance system is displayed here on the display 2 of the combination instrument. In order to visualize that the additional driver assistance system is inactive, the symbol 14 is not illuminated.

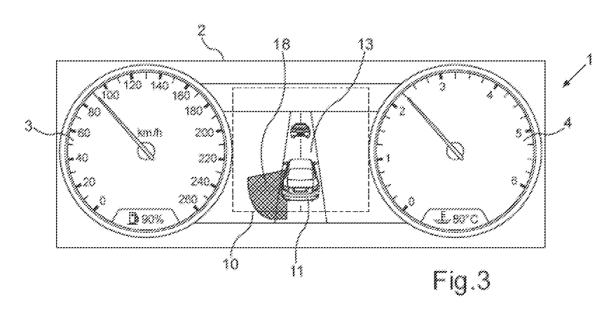

FIG. 3 shows the display device 1 of the motor vehicle that is operated in a first driving mode. The first driving mode can be a partially automated driving mode. This driving mode has a higher degree of automation than the assisted driving mode. Here, the driver and a first active driver assistance system control the motor vehicle together. The driver thus acts as a monitor for the functions of the first active driver assistance system. In this exemplary embodiment, the first active driver assistance system is implemented as a lane change assistant.

A first assistance graphic 10, which is assigned to the first driver assistance system, in particular the lane change assistant, is displayed on a display 2 of the combination instrument. In order to make it clear to the driver that the motor vehicle is in the partially automated driving mode, the first assistance graphic is depicted in a first perspective. The first assistance graphic 10 here shows a virtual motor vehicle 11 that depicts the motor vehicle in which the driver is located from a bird's eye perspective. In the case of lane change assistants, traffic behind the vehicle in a targeted lane as well as areas near to and a short area in front of the motor vehicle in the targeted lane are relevant. Special attention is to be paid to these areas. For this reason, the regions to be monitored are provided with a marking 18 in the first assistance graphic 10. Such a marking 18 can, for example, be implemented in such a way that the regions to be monitored are highlighted in color.

Provision can be made, for example, for the motor vehicle to be in the assisted driving mode at first, which is described in FIG. 1 and in which the adaptive cruise control is displayed as a first assistance graphic 10 on the display 2 of the combination instrument. In addition, further driving assistance systems are active, for example the lane change assistant. The lane change assistant can be a permanently active system, which, in the event of a change in state, notifies the driver of its state irrespective of the display mode (for example the third display mode, which is assigned to the third driving mode, i.e., assisted driving) selected in the display 2 of the combination instrument. When such a permanent active driver assistance system, for example the lane change assistant, is activated in order to carry out a certain maneuver, the motor vehicle is operated in the first driving mode, for example, for the duration of the maneuver. It can therefore be provided that the assistance graphic which is assigned to the lane change assistant is displayed on the display device 1 from activation until the end of maneuvering as a so-called pop-up, in particular as a temporary pop-up, and thus covers the assistance graphic assigned to the adaptive cruise control. The overlapping assistance graphic, i.e., the assistance graphic of the lane change assistant, is displayed in the display mode, i.e., in the perspective, which is assigned to the first driving mode. It can thus be visualized to the driver which driving mode the motor vehicle is in.

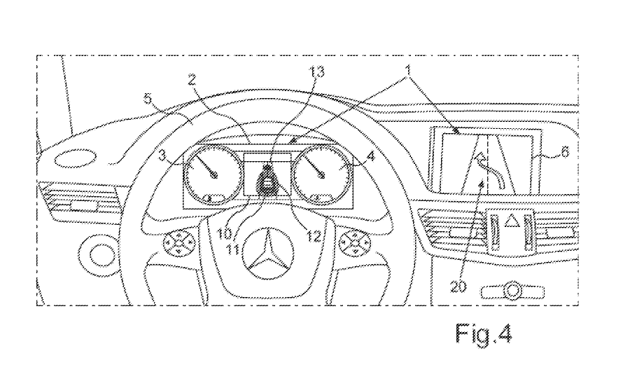

FIG. 4 shows a display device 1 of a motor vehicle operated in a second driving mode. The second driving mode can, for example, be implemented as a highly automated driving mode. During highly automated driving, a driver of the motor vehicle hands over vehicle guidance to the motor vehicle. The motor vehicle is operated, for example, by a first active driver assistance system. Therefore, the driver does not have to permanently monitor the motor vehicle. The driver and all other vehicle passengers can thus be driven by the motor vehicle in a relaxed manner. The display device 1 is implemented as a combination instrument located behind a steering wheel of the motor vehicle. The combination instrument can be implemented to be structurally identical to the combination instrument of the figures described above.

A first assistance graphic 10 of the first active driver assistance system is displayed on the display 2 of the combination instrument. The display on the display 2 of the combination instrument thus differs significantly from a display of a manual driving mode, in particular an assisted driving mode. The highly automated driving mode is thus to be confirmed to the driver. In order to visualize to the driver who is responsible for guiding the vehicle, essential content can be depicted on the display. This content can be, for example, the driving speed and relevant traffic and prohibition signs, for example a speed limit or a ban on overtaking.

If provision is made for the driver to take back control of the vehicle, i.e., the second driving mode is to be switched to the first driving mode, for example, a video image of the current driving scene can, for example, be inserted on the display 2 of the combination instrument for the driver at specific time intervals after acoustic warning. The video can be hidden again by acknowledgement from the driver after a defined minimum display period. During video insertion, provision can be made for other displays, which are arranged in the motor vehicle and which can be seen from a driver's seat, to be darkened.

A further option to direct the driver's attention to the traffic may be to provide an acoustic signal instead of inserting the video image. After this acoustic signal, all the displays visible to the driver can be darkened, or a notice, for example, the wording “observe traffic surroundings” can be inserted.

In addition, provision can be made for a graphic 20 to be displayed to the driver, for example on the display 6 of a head unit which can be arranged in a center console of the motor vehicle, said graphic depicting a driving maneuver planned by the motor vehicle. This maneuver-based preview means that it can be made clear to the passengers of the motor vehicle what the motor vehicle will do in the next couple of seconds. For example, the following maneuvers can be displayed: Lane changes, overtaking maneuvers, turning maneuvers, adjustment of the driving speed to the current limit.

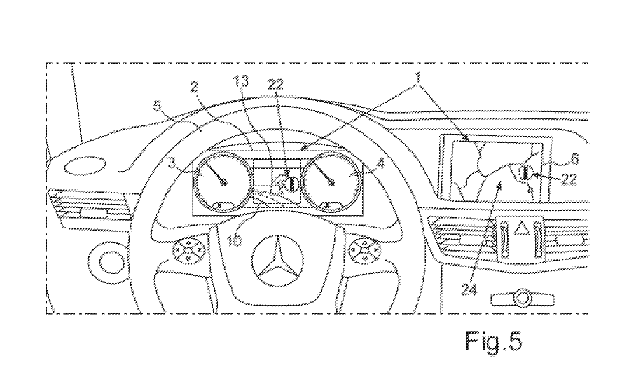

FIG. 5 shows a further embodiment of a depiction of the first assistance graphic 10 on the display device 1 of a motor vehicle. The vehicle is in a second driving mode. Potential hazards 22 can be detected by a sensor system of the motor vehicle. These potential hazards 22 can be depicted in the first assistance graphic 10 on the display device 1, which is implemented as an instrument cluster. The instrument cluster comprises a display 2 of a combination instrument and a display 6 of a head unit.

Since the motor vehicle is in a highly automated driving mode here, it can be signaled to the driver that the motor vehicle is controlling the situation by way of the depiction of potential hazards 22 in the first assistance graphic 10. Potential hazards can be incidents an experienced driver would observe with particular attention. This can, as shown here in the display 2 of the combination instrument, be a broken-down motor vehicle. If so desired by the driver, the location of the broken-down vehicle can additionally be marked on a map 24, which can be depicted on the display 6 of the head unit. If there are several people in the motor vehicle, then the information can be displayed in such a way that it can be seen by all people. If the front seats are rotatable, the information should be visible to all passengers in the rear seats.

Other hazards 22 may, for example, be oncoming traffic in a narrow road such that the motor vehicle must stop or steer towards the right, or a cyclist in the lane of the motor vehicle which can only be overtaken by leaving the lane towards the left. Further examples of hazards 22 are: children playing who may suddenly step into the road, an animal running freely, a traffic light whose signal must be observed, a junction which a vehicle with right of way is approaching, or also road users who do not have right of way who are in danger of violating this responsibility.

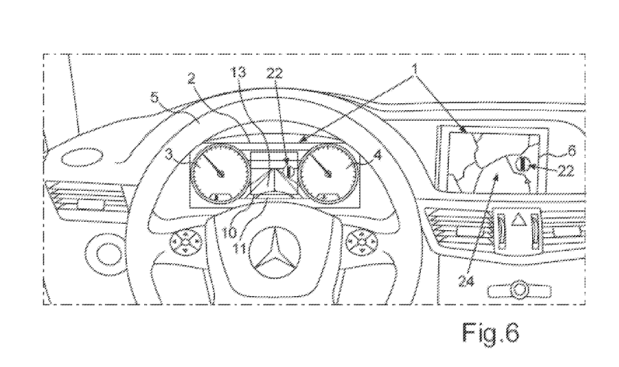

FIG. 6 shows a further embodiment of a depiction of the first assistance graphic 10 on the display device 1 of a motor vehicle. The vehicle is in a third, in particular assisted, driving mode. The display device 1 is implemented as an instrument cluster. The instrument cluster comprises a display 2 of a combination instrument and a display 6 of a head unit.

Here, a first assistance graphic 10 for a lane change assistant is displayed on the display 2 of the combination instrument, for example. The first assistance graphic 10 is displayed in the display mode, i.e., in the perspective, which is assigned to the assisted driving mode. In addition, a hazard 22 is marked in the first assistance graphic 10. This can be a broken-down vehicle, for example. The location of the hazard 22 can, as shown in FIG. 5, furthermore be displayed on a map 24 which can be depicted on the display 6 of the head unit.

Overall, the exemplary embodiments show a display concept for assisted, partially automated or highly automated driving. A remaining driver's task is visualized by a perspective of the assistance graphic which is assigned to the degree of automation.

Although the present invention has been described above by means of embodiments with reference to the enclosed drawings, it is understood that various changes and developments can be implemented without leaving the scope of the present invention, as it is defined in the enclosed claims.

1-10. (canceled)

11. A method for operating a motor vehicle, the method comprising:
displaying a first assistance graphic of a first active driver assistance system in a first display mode on at least one display device of the motor vehicle when the motor vehicle is operated in a first driving mode; and
displaying the first assistance graphic of the first active driver assistance system in a second display mode on the at least one display device when the motor vehicle is operated in a second driving mode that is different from the first driving mode,
wherein the first assistance graphic is displayed in a first perspective in the first display mode and in a second perspective, which is different from the first perspective, in the second display mode.

12. The method of claim 11, wherein the at least one display device is a head-up display, a display of a combination instrument of the motor vehicle, or a display of a head unit of the motor vehicle.

13. The method of claim 11, wherein the motor vehicle is operated in a partially automated manner in the first driving mode and the motor vehicle is operated in a highly automated manner in the second driving mode.

14. The method of claim 11, wherein
the first assistance graphic comprises at least one region in surroundings of the motor vehicle or at least one hazard in the surroundings of the motor vehicle, and
the at least one region or the at least one hazard are detected by a detection device of the first active driver assistance system.

15. The method of claim 14, wherein
the at least one region in the first display mode is marked by a first marking and the region in the second display mode is marked by a second marking, which is different from the first marking, and
the first marking highlights the at least one region to be monitored by the driver and the second marking highlights the at least one region that is monitored by the first active driver assistance system.

16. The method of claim 11, wherein in the second driving mode, a planned vehicle maneuver of the first active driver assistance system is displayed on the at least one display device.

17. The method of claim 11, wherein at least one third driving mode is provided in which the first assistance graphic is displayed in a third perspective on the at least one display device in a third display mode.

18. The method of claim 11, wherein a second assistance graphic of at least one second driver assistance system, which is only active for a predetermined time period, is depicted on the at least one display device in such a way that the second assistance graphic overlaps the first assistance graphic.

19. The method of claim 11, further comprising:
issuing a warning signal before switching from the second driving mode into the first driving mode, wherein the warning signal is issued visually, acoustically, or haptically.

20. A motor vehicle, comprising:
at least one display device;
a first active driver assistance system; and
a controller coupled to the at least one display device and the first active driver assistance system, wherein the controller causes the at least one display device to display a first assistance graphic of the first active driver assistance system in a first display mode when the motor vehicle is operated in a first driving mode, the controller causes the at least one display device to display the first assistance graphic of the first active driver assistance system in a second display mode when the motor vehicle is operated in a second driving mode that is different from the first driving mode,
wherein the first assistance graphic is displayed in a first perspective in the first display mode and in a second perspective, which is different from the first perspective, in the second display mode.
